(19) United States
(12) Patent Application Publication
(10) Pub. No.: US 2026/0205953 A1
(43) Pub. Date: Jul. 16, 2026

(54) POWER CONFIGURATION FOR ENERGY HARVESTING DEVICE WITH BATTERIES

(71) Applicant: QUALCOMM Incorporated, San Diego, CA (US)

(72) Inventors: Ahmed ELSHAFIE, San Diego, CA (US); Zhikun WU, Beijing (CN); Yuchul KIM, San Diego, CA (US); Huilin XU, Temecula, CA (US); Linhai HE, San Diego, CA (US); Seyedkianoush HOSSEINI, San Diego, CA (US); Peter GAAL, San Diego, CA (US); Wanshi CHEN, San Diego, CA (US); Tingfang JI, San Diego, CA (US); Krishna Kiran MUKKAVILLI, San Diego, CA (US)

(21) Appl. No.: 19/139,243

(22) PCT Filed: Jan. 27, 2023
(86) PCT No.: PCT/CN2023/073493

§ 371 Date: Jun. 13, 2025

(51) Int. Cl. H04W 52/02; H02J 50/00

(52) U.S. Cl. CPC H04W 52/0277; H02J 50/001

(57) ABSTRACT

Method and apparatus for a power configuration for energy harvesting (EH) devices comprising batteries. The apparatus receives, from a network device, at least one command. The at least one command comprises a power configuration including a proportional power indication for operation of the energy harvesting device. The apparatus communicates with the network device based on the power configuration including the proportional power indication for the operation of the energy harvesting device. The apparatus may transmit, to the network device, an ACK or a NACK in response to the at least one command indicating whether the energy harvesting device supports the power configuration.

### TECHNICAL FIELD

The present disclosure relates generally to communication systems, and more particularly, to a power configuration for energy harvesting (EH) devices comprising batteries.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a network device, at least one command, wherein the at least one command comprises a power configuration including a proportional power indication for operation of the energy harvesting device; and communicates with the network device based on the power configuration including the proportional power indication for the operation of the energy harvesting device.

In an aspect of the disclosure, a method, a computer-readable medium, and an apparatus are provided for wireless communication at a network device. The apparatus configures a power configuration including a proportional power indication for operation of an energy harvesting device; provides, to the energy harvesting device, at least one command comprising the power configuration including the proportional power indication; and communicates with the energy harvesting device based on the power configuration including the proportional power indication for the operation of the energy harvesting device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example of an RFID tag that receives an energy transfer signal from an RFID reader.

FIGS. 5A-5B illustrate an example of an RFID tag utilizing amplitude-shift keying (ASK) modulation.

FIG. 6 illustrates an example of a backscatter communication timeline between an RF source and an RFID tag device.

FIG. 7 illustrates an example of an active cycle for EH devices.

FIG. 8 illustrates an example timeline of communication between an RF source and an EH device.

FIG. 9 illustrates an example of an ON time and a harvesting time for an EH device.

FIG. 10 is a call flow diagram of signaling between a UE and a network device.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a flowchart of a method of wireless communication.

FIG. 16 is a diagram illustrating an example of a hardware implementation for an example network entity.

### DETAILED DESCRIPTION

A device (e.g., a UE) may include a EH harvesting modality (e.g., a backscatter radio). In an example, the device may receive an energy transfer signal from a network node. The device may harvest energy from the energy transfer signal to perform an operation during a communication phase with the network node. The device may receive a power configuration comprising a proportional power indication for operation of the EH device. The proportional power indication may indicate an amount of power usage of the battery and an amount of direct energy utilized by the EH device during a time interval. At least one advantage of the disclosure is that the power configuration may allow for efficient use of the battery and the harvested energy for operation of the EH device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

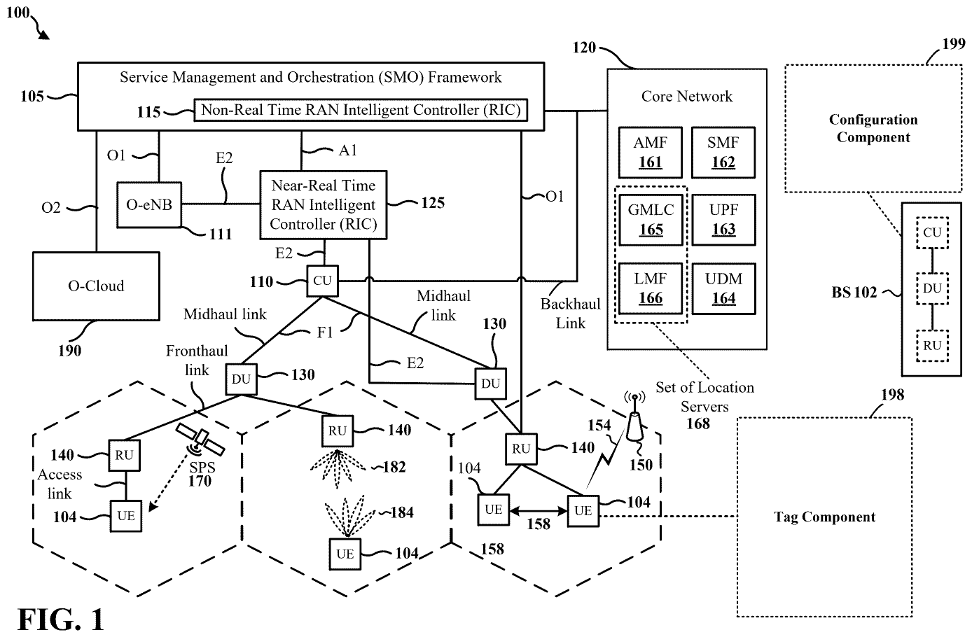

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a tag component 198 configured to receive, from a network device, at least one command, wherein the at least one command comprises a power configuration including a proportional power indication for operation of the energy harvesting (EH) device; and communicate with the network device based on the power configuration including the proportional power indication for the operation of the EH device.

Referring again to FIG. 1, in certain aspects, the base station 102 may comprise a configuration component 199 configured to configure a power configuration including a proportional power indication for operation of a EH device; provide, to the EH device, at least one command comprising the power configuration including the proportional power indication; and communicate with the EH device based on the power configuration including the proportional power indication for the operation of the energy harvesting device.

Although the following description may be focused on 5G NR, the concepts described herein may be applicable to other similar areas, such as LTE, LTE-A, CDMA, GSM, and other wireless technologies.

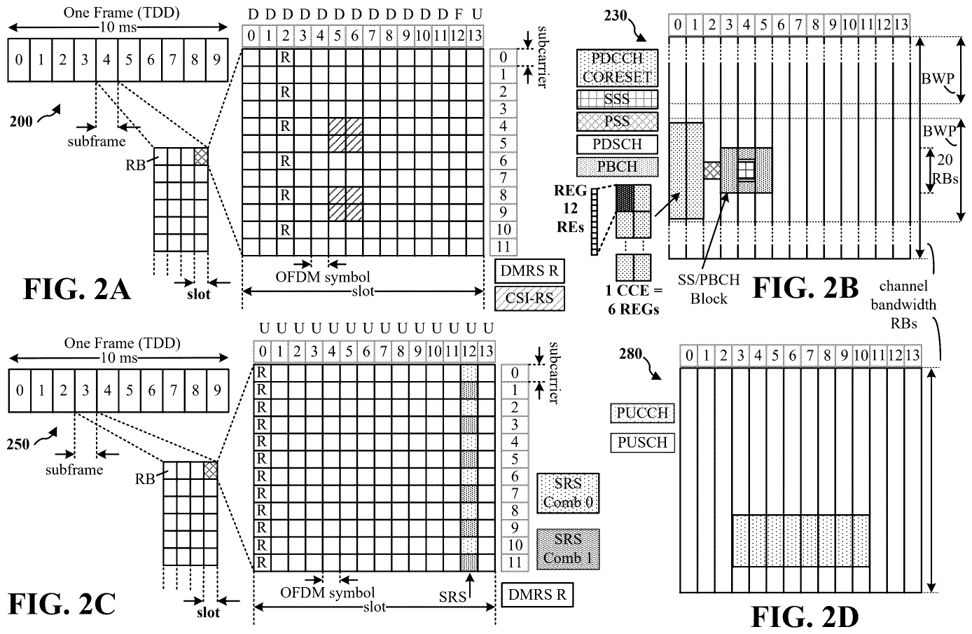

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

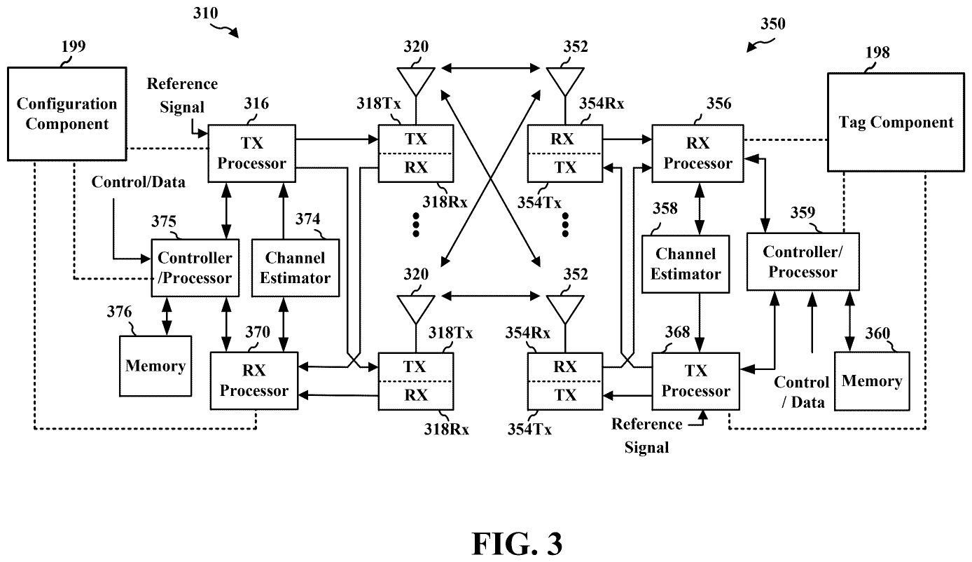

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the tag component 198 of FIG. 1.

At least one of the TX processor 316, the RX processor 370, and the controller/processor 375 may be configured to perform aspects in connection with the configuration component 199 of FIG. 1.

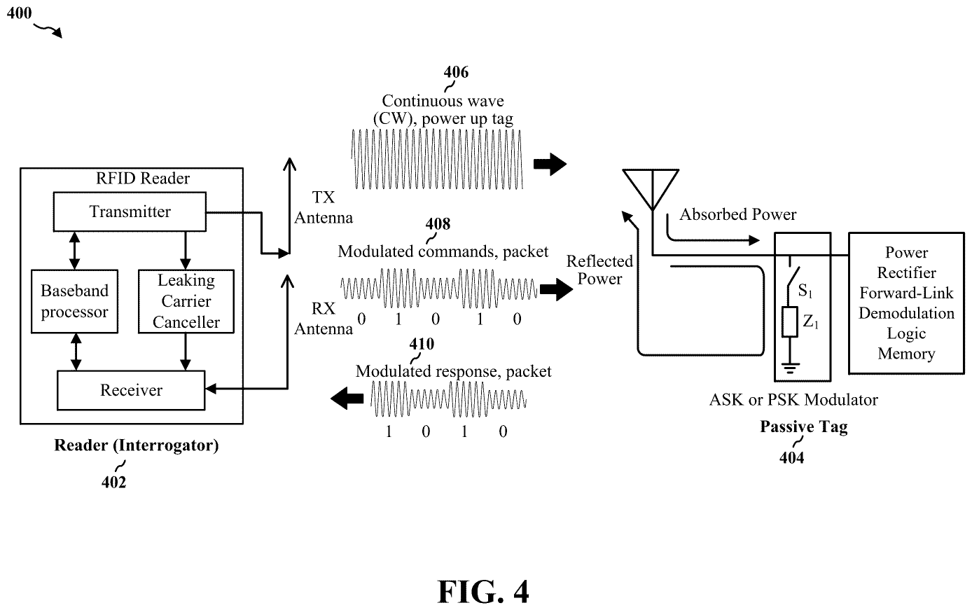

In some aspects, a wireless communication system may include one or more devices that harvest or acquire energy from a wireless signal and use the harvested energy for wireless communication, sensing, or other operations of the device. In some aspects, a device (e.g., a UE) may include a EH harvesting modality (e.g., a backscatter radio). For example, FIG. 4 illustrates a diagram 400 of an RFID tag 404 that receives an energy transfer signal 406 from an RFID reader 402. The RFID tag 404 is an example of an energy receiver that may obtain energy from an energy transfer signal (or an energy signal) from an energy transmitter (e.g., the RFID reader 402). An energy transfer signal 406 may comprise a continuous wave (CW) that may be utilized to power up the RFID tag 404. The RFID tag 404 may be a passive tag that does not have a power source and thereby harvests energy from the energy transfer signal 406 for power. Upon the RFID tag 404 being powered up, the RFID reader 402 may provide a modulated signal 408 that may comprise one or more commands. RFID devices may include a transponder (e.g., the RFID tag 404) that emits an information-bearing signal, such as a backscattered modulated information signal 410, upon receiving a signal (e.g., 406, 408) from the RFID reader 402. That is, the RFID reader 402 may transmit the energy transfer signal 406 as well as an information signal to a passive RFID microchip (e.g., RFID tag 404) that operates without a battery source.

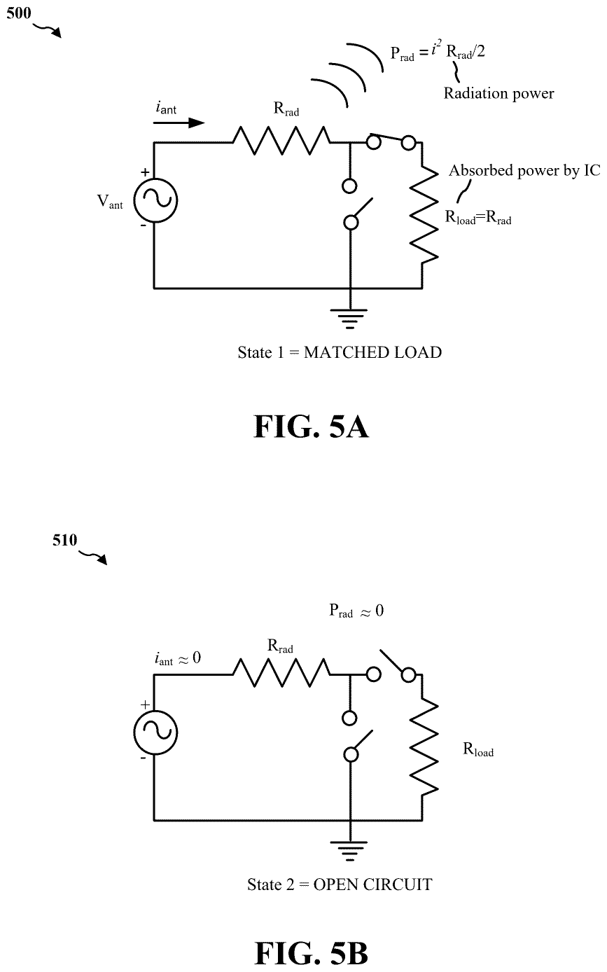

In some instances, the RFID tag 404 may utilize amplitude-shift keying (ASK) modulation, as shown for example in diagram 500 of FIG. 5A or diagram 510 of FIG. 5B. In such instances, the RFID tag may modulate signals at a different state to represent different backscatter power. For example, the RFID tag, in diagram 500 of FIG. 5A, may have large backscatter power when the load is matched, such that the radiation power (Prad) is the same as the absorbed power (across Rload) by the circuit. The RFID tag, in diagram 510 of FIG. 5B, may have no backscatter power.

The RFID tag 404 may be configured to operate without the battery source at a low operational expenditure (OPEX), low maintenance cost, and/or increased lifecycle. Other types of RFID tags may include battery sources. For example, semi-passive RFID devices and active RFID devices may have a battery source, but may also be associated with a higher cost. If the RFID reader 402 is able to provide enough received energy to the RFID tag 404, the RFID tag 404 may harvest the received energy to perform an operation during communication occasions or may harvest the received energy to charge an associated battery. Passive RFID tags may harvest the received energy over-the-air in order to power transmit/receive circuitry at the RFID tag 404. The energy transfer signal 406 transmitted to the RFID tag 404 may trigger the backscattered modulated information signal 410 from the RFID tag 404. The RFID tag 404 may absorb or reflect signals from the RFID reader 402 based on the information to be communicated between the RFID tag 404 and the RFID reader 402. The RFID tag 404 may include a decreased number of active RF components (e.g., no active RF component) in some cases.

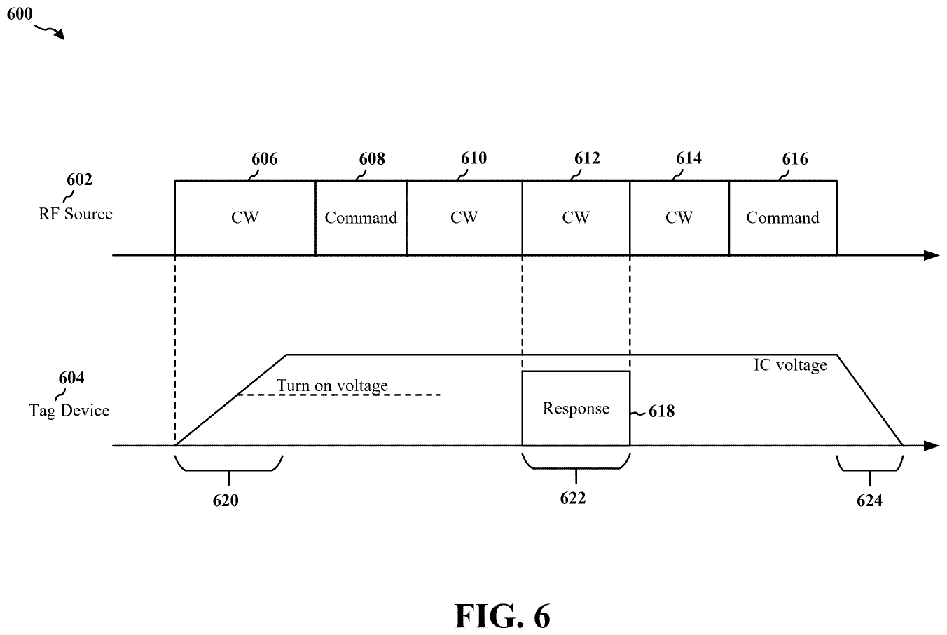

FIG. 6 illustrates a diagram 600 of an example of a backscatter communication timeline between an RF source 602 and an RFID tag device 604 that uses power from an incoming transmission to power the RFID tag device 604. The RFID tag device 604 may be a passive device. In some aspects, the RFID tag device 604 may be a semi-passive device or an active device. The RF source 602 may be, for example, the UE 104 or the base station 102 in FIG. 1, a network unit/node/entity (e.g., RAN node, relay node, IAB node, etc), or any other wireless device. When a signal is not being transmitted to the RFID tag device 604, the RFID tag device 604 may be in idle mode. When the RFID tag device 604 is in idle mode, the RFID tag device 604 may use an incoming transmission to power the device.

The RF source 602 may transmit a CW signal 606 during the time period 620. The time period 620, for example, may be greater or equal to 400 μS. The CW signal 606 may be used to turn on the voltage at the RFID tag device 604. Power from the CW signal 606 may be directed to one or more capacitors of the RFID tag device 604 to activate components of the RFID tag device 604, such as an integrated circuit (IC) or a demodulator. After a threshold period of time, for example at least 400 μS, the RFID tag device 604 may have collected enough voltage to be powered up and able to receive an instruction from the RF source 602.

The RF source 602 may transmit a command 608 to the RFID tag device 604. The command 608 may provide both information and power to the RFID tag device 604. Information may be in the form of a signal having an instruction for the RFID tag device 604 to implement, and power in the form of a received RF signal that may be passed through a rectifier to provide power for the RFID tag device 604. The command 608 may have a signal strength greater or equal to a threshold value, such as −20 dBm, to provide both information and power to the RFID tag device 604.

The RF source 602 may continue to provide a CW signal 610 to maintain the power level of the RFID tag device 604. The CW signal 610 may have a signal strength greater or equal to a threshold value to ensure that the IC chip of the RFID tag device 604 remains turned on to process the command 608 received earlier. The RFID tag device 604 may transmit a response 618 during the time period 622 to a reader device. The reader device may be the RF source 602 (e.g., in a monostatic system), or the reader device may be a different wireless device (e.g., in a bistatic system). The reader device may be a unit, relay, entity that supports reception of the signal from the RFID tag device. The RF source 602 may continue to provide a CW signal 612 to maintain the power level of the RFID tag device 604. The CW signal 612 may have a signal strength greater or equal to a threshold value to ensure that the IC chip of the RFID tag device 604 remains turned on during the time period 622. The CW signal 614 may be used both to provide power to the RFID tag device 604 and to provide a carrier wave for tag modulation at the RFID tag device 604. In other words, the response 618 may be a reflected signal of the CW signal 612, which has the response modulated with the reflected signal.

The RF source 602 may continue to provide a CW signal 614 to maintain the power level of the RFID tag device 604. The CW signal 614 may have a signal strength greater or equal to a threshold value to ensure that the IC chip of the RFID tag device 604 remains turned on. The RF source 602 may provide a command 616 to the RFID tag device 604. The command 616 may provide both information and power to the RFID tag device 604. Information may be in the form of a signal having an instruction for the RFID tag device 604 to implement, and power in the form of a received RF signal that may be passed through a rectifier to provide power for the RFID tag device 604. The command 616 may have a signal strength greater or equal to a threshold value, such as −20 dBm, to provide both information and power to the RFID tag device 604. The RF source 602 may stop transmitting a CW signal during the time period 624. During the time period 624, the voltage of the RFID tag device 604 may drop and it may once again be switched to idle mode to remain dormant until a signal is transmitted to the RFID tag device 604 to power it up again.

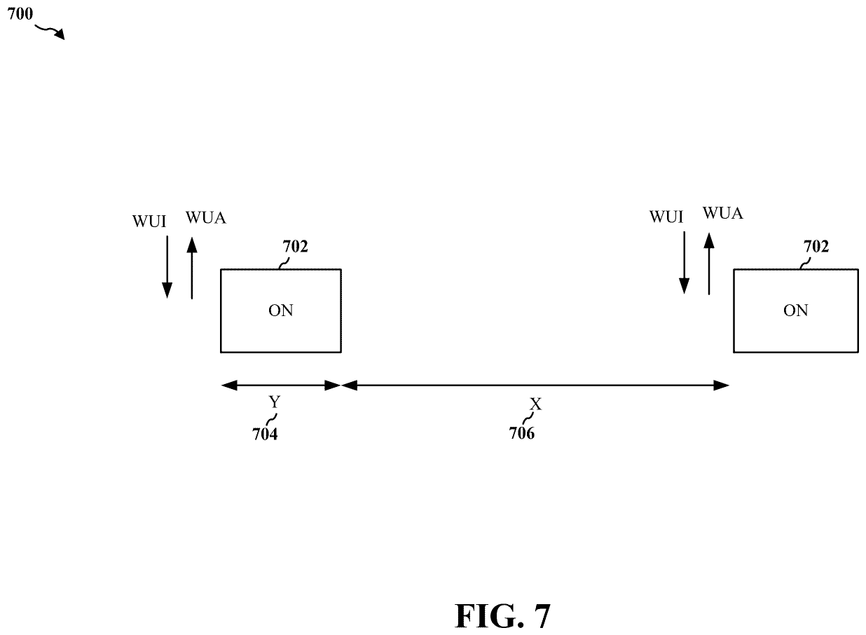

FIG. 7 illustrates a diagram 700 of an example of an active cycle for EH devices (e.g., RFID tag devices). The active cycle may be designed based on a certain input power to an EH device and the power consumed by the device during activity. For example, if the input power is Pₓ and the RF-to-DC conversion efficiency at Pₓ is ηₓ, then the harvested power is Pₓ·ηₓ. Assuming that an IC power of P_{y} and a reading duration of Y 704 time units, such that the EH device is on 702, then the condition to operate may be given by Pₓ·ηₓ·X≥P_{y}. Y. A causality condition or constraint may comprise that accumulated energy must be higher than consumed energy. Thus, a harvesting duration (e.g., X 706) may be

$$X \geq \frac{{P}_{y} \cdot Y}{{P}_{x} \cdot {η}_{x}}$$

with

$$\frac{X}{Y} \geq \frac{{P}_{y}}{{P}_{x} \cdot {η}_{x}}$$

which may lead to an EH-to-Activity time ratio.

Assuming a −37 dBm input power with a certain RF-to-DC conversion efficiency (e.g., 10%), then the harvested power may comprise −47 dBm, where −37 dBm may be a tag sensitivity value. An accumulation of power, over X time units (e.g., slots), may comprise −47+10*log 10(X). With an assumption of an IC having 10 μW (e.g., −20 dBm) that operates for Y time units (e.g., slots), then for the device to be able to be in an ON or active state during the Y time units, the following condition is present −47+10*log 10(X)>=−20+10*log 10(Y), where X/Y≥501, which may be the ratio between harvesting state to usage/activity state. As such, if the EH device (or an IC with 10 μW power consumption) has to wake up (e.g., activate or ON state) for Y time units, then the IC needs to harvest for X time units, where X/Y=500. For example, for reading an RFID tag, the RF source may utilize 10 slots (e.g., 10 msec for 15 kHz SCS system), the RFID tag may accumulate energy for 5 ms or 5 seconds. Thus, if the input power is-37 dBm, and assuming 10 μW power consumption, the RFID tag may activate every 5 seconds to operate for 10 msec.

In some instances, the EH device may comprise a battery or energy storing capabilities, such that the EH device may be a semi-passive device or an active device. The power required may be 20 dB less than a passive RFID tag which consumes RF energy harvesting for powering the IC. RFID tags with a battery may use the battery for IC power such that-35 dBm, for example, input power to device may be reasonable for proper decoding and operation. RFID tags with a battery may partially use the battery, for example, 30% from the battery and 70% from the RF signal. The above may change the input power to the tag, e.g., power control from the RF source.

Aspects presented herein provide a power configuration for EH devices having batteries. The EH device may receive a power configuration comprising a proportional power indication for operation of the EH device. The proportional power indication may indicate an amount of power usage of the battery and an amount of direct energy utilized by the EH device during a time interval. At least one advantage of the disclosure is that the power configuration may allow for efficient use of the battery and the harvested energy for operation of the EH device.

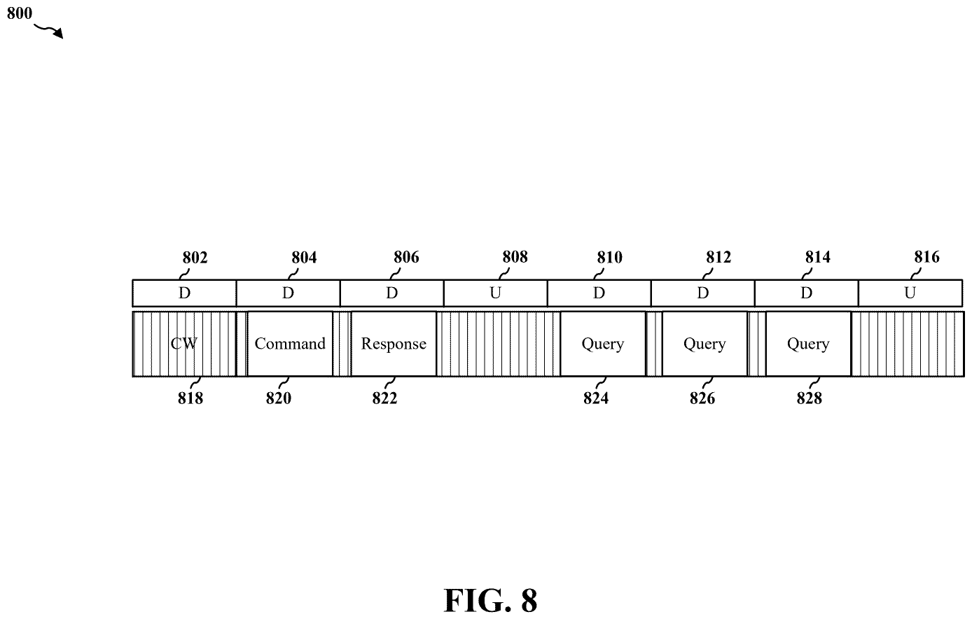

FIG. 8 shows a diagram 800 of an example timeline of communication between an RF source and an EH device. In some aspects, an RF source (not shown) may transmit a CW signal 818 to the RFID tag (not shown) at time occasions 802, 804, 806, 808, 810, 812, 814, and 816 to ensure that the RFID tag device that receives the CW stays activated. At time occasions 802, 804, 806, 810, 812, and 814, the RF source may be configured to communicate with the RFID tag device. Time occasions 802, 804, 806, 810, 812, and 814 may also be referred to as response occasions. The RFID tag device may be configured to backscatter a received CW signal during the response occasions, such as 802, 804, 806, 810, 812, and 814.

In some instances, the command 820 may be a command to query to setup the tag device. The command 820, from the RF source, may setup how much battery is used and how much direct RF energy is used during a time interval of T time units or until a new command is received (e.g., activation or deactivation command). This may be partially based on the power set point that the RF source is willing to use, where the RFID tag uses the battery energy accordingly. For example, −35 dBm may indicate that 100% of the battery is used to power the IC of the tag device during T seconds (time units). In another example, −10 dBm may indicate that 0% of the battery is used to power the IC of the tag device during T second (time units). If the RFID tag radio is a partial radio of a hybrid radio of an RFID tag plus main radio (MR), then the MR may be used to control the RFID tag radio when RFID radio is ON or is used or to negotiate values as discussed above. In some cases, the MR may be ON, or the RFID tag radio may be ON, or both the MR and the RFID tag may be ON. The MR may be utilized alone in instances where the RF source wants to lower interference and manage environment or achieve higher data or reliability. In some instances, the RFID tag may be used when low power or low data rate is desirable. In some instances, the RFID tag may use both in same or different frequency to achieve diversity or improve performance.

In some aspects, if the MR is ON or becomes ON after a command (e.g., 820) to wakeup is received by the RFID tag, then the MR may be configured to send an ACK or NACK of one or more commands to the RF source or RF reader. In some aspects, the RF source may comprise the RF reader. For example, the ACK may indicate that such a command is supported by the RFID tag. In some aspects, the NACK may indicate that such a command may not be supported by the RFID tag. In such instances, a command may be resent. In some aspects, if the RFID tag is ON, the RFID tag may be configured to handle the backscattering. For example, the RFID tag may transmit the ACK/NACK feedback within response 822 in response to the command 820. In some instances, multiple ACK/NACK responses may be bundled for every K commands and feedback may be sent by the MR or backscattered by the RFID tag. The RF source may communicate with the RFID tag at 824, 826, and/or 828, for example, by transmitting queries to the RFID tag.

In some aspects, a HARQ-ACK of the reading process may be sent to the RFID tag. The HARQ-ACK of the reading process may be sent to RFID tag if RFID tag has an MR (e.g., hybrid architecture in a UE). The HARQ-ACK information may then be sent to MR. Then the RFID tag may backscatter the HARQ-ACK information back to RF source. The process may be repeated in instances where a NACK is sent.

In some aspects, the RFID tag may be configured to provide feedback related to the status of the RFID tag. For example, the RFID tag may be configured to indicate that the RFID tag is unable to use the battery. In some instances, the battery may not have a sufficient charge for a desired battery power usage, the battery charge rate is low, or the battery may be dead. In another example, the RFID tag may be configured to indicate that it needs a new or updated power configuration, such that the ratio between the RF power and energy harvested from the incident signal and use of the battery power.

In some aspects, in addition to the HARQ-ACK of commands and the reading process, the RFID tag may be configured to send information related to its capabilities. For example, the RFID tag may indicate the RFID tag's ability to use a certain amount of desired power using the battery. The RFID tag may be configured to indicate whether the RFID tag supports the power configuration provided by the RF source by sending an ACK/NACK. In some aspects, the MR may be used to generate, feedback, or relay such information, or part of such information, when the MR is ON.

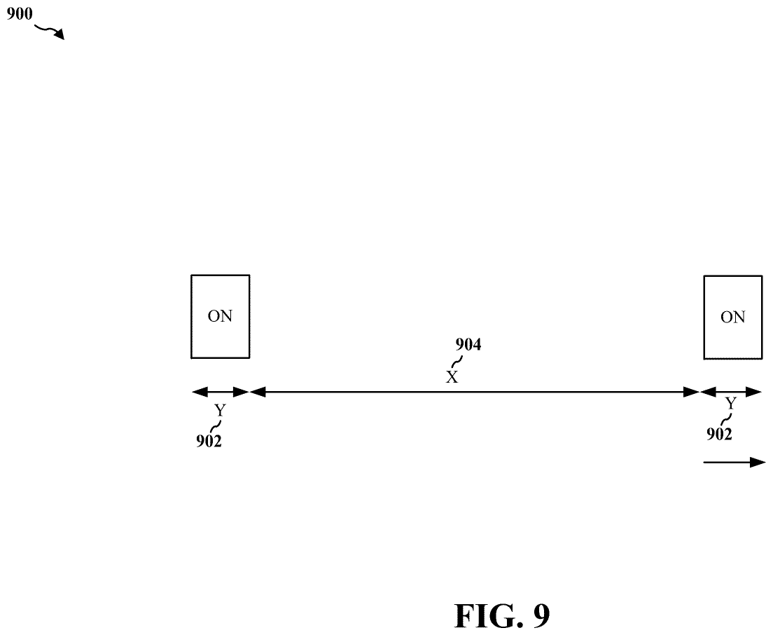

In some aspects, an RFID tag may indicate a processing time to process data. The processing time may also correspond or define the time the RFID tag is awake, and may correspond to a harvesting time to collect energy based on a current charge rate of the RFID tag. In some aspects, an RFID tag, in response to a command to start reading, may indicate the energy harvesting time X 904 and the ON time Y 902, as shown for example in diagram 900 of FIG. 9. In some aspects, the RFID tag may indicate Pₓ·ηₓ, X, P_{y}, Y in Pₓ·ηₓ·X≥P_{y}·Y.

In some aspects, RFID tag may indicate different values for X 904 and Y 902 for different values of Pₓ, such that the RF source may decide which one to be used. The RFID tag can also indicate for different values of battery utilization. The battery may be disposal with no charging requirements (e.g., as in semi-passive RFID tags), or may be charged based on RF, solar, vibration, light/laser, or the like.

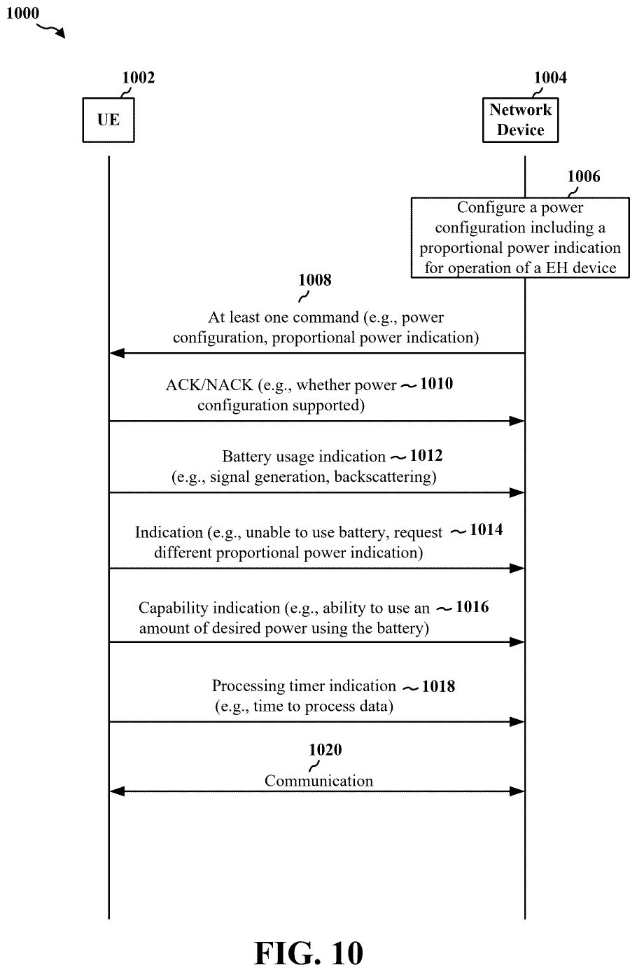

FIG. 10 is a call flow diagram 1000 of signaling between a UE 1002 and a network device 1004. The UE 1002 may comprise an energy harvesting (EH) device. The EH device may comprise a passive EH device, a semi-passive EH device, or an active EH device, and may be configured to communicate with the network device 1004. For example, in the context of FIG. 1, the network device 1004 may correspond to base station 102 or UE 104 and the UE 1002 may correspond to at least UE 104. In another example, in the context of FIG. 3, the network device 1004 may correspond to base station 310 and the UE 1002 may correspond to UE 350.

At 1006, the network device 1004 may configure a power configuration. The power configuration may include a proportional power indication for operation of the EH device.

At 1008, the network device 1004 may provide at least one command comprising the power configuration including the proportional power indication. The network device may provide the at least one command to the EH device. The EH device may receive the at least one command comprising the power configuration including the proportional power indication from the network device 1004. The at least one command may comprise a power configuration including a proportional power indication for operation of the EH device. In some aspects, the proportional power indication may indicate an amount of power usage of a battery of the EH device and a direct energy that may be utilized during a time interval. In some instances, the time interval may be based on one or more time units. In some instances, the time interval may be based on reception of a new command. For example, the time interval may terminate upon receipt of a new command. In some aspects, the EH device may be comprised within a main radio device. The main radio device may comprise a UE. In some aspects, the EH device may be controlled by the main radio device to negotiate values of the proportional power indication or when the EH device is in an active state.

At 1010, the UE 1002 may transmit an ACK or a NACK in response to the at least one command. The UE may transmit the ACK or the NACK to the network device 1004. The network device 1004 may receive the ACK or the NACK from the UE 1002. The ACK or the NACK may indicate whether the EH device supports the power configuration. In some aspects, the ACK or the NACK in response to the at least one command may be transmitted by a main radio device when the main radio device is in an active state. In some aspects, the EH device may transmit the ACK or the NACK in response to the at least one command when the main radio device is in an inactive state. In some aspects, feedback related to backscattering may be transmitted by the main radio device when the main radio device is in an active state. In some aspects, feedback related to backscattering and the ACK or the NACK in response to the at least one command may be transmitted by the EH device. The ACK or the NACK, in response to the at least one command, may be bundled for a plurality of commands. For example, the ACK or NACK may be bundled every K commands such that feedback for the K commands may be sent by the main radio or backscattered by the EH device. In some aspects, a HARQ-ACK of a reading process for the EH device may be provided to the main radio device, such that the EH device may provide a response to the HARQ-ACK via backscatter.

At 1012, the UE 1002 may transmit an indication of a battery usage to the network device 1004. The network device 1004 may receive the indication of the battery usage from the UE 1002. The indication may indicate the battery usage may by the EH to generate a signal or backscattering for the EH device.

At 1014, the UE 1002 may transmit an indication related to the battery usage or the proportional power indication to the network device 1004. The network device 1004 may receive the indication related to the battery usage or the proportional power indication from the UE 1002. In some aspects, the EH device may transmit an indication indicating that the EH device is unable to utilize the battery. For example, the battery may not be utilized because the batter has expired or does not have a sufficient charge to meet the requirements of the EH device. In some aspects, the EH device may transmit an indication indicating a request for a different proportional power indication. For example, a new proportional power indication may be needed if the current proportional power indication is invalid or has expired.

At 1016, the UE 1002 may transmit a EH device capability to the network device 1004. The network device 1004 may receive the EH device capability from the UE 1002. The EH device capability may indicate an ability of the EH device to utilize an amount of desired power using the battery. The EH device may transmit the EH device capability to the network device. For example, the EH device may indicate that the EH device may or may not be able to use the desired amount of power from the battery in response to the at least one command.

At 1018, the UE 1002 may transmit a processing timer indication to the network device 1004. The network device 1004 may receive the processing timer indication from the UE 1002. The processing timer indication may indicate an amount of time to process data. The processing timer may indicate an active time, where a harvest time to collect energy may be based on the active time. In some aspects, the processing timer may be provided to the network device in response to the at least one command.

At 1020, the UE 1002 may communicate with the network device based on the power configuration including the proportional power indication for the operation of the EH device. in some aspects, at least one of a receive power, an energy conversion efficiency, a harvesting duration, an amount of harvested power, a EH device active duration, or a EH device power consumption may be provided to the network device. Different values for the harvesting duration or the EH device active duration may be provided to the network device for different values of the receive power.

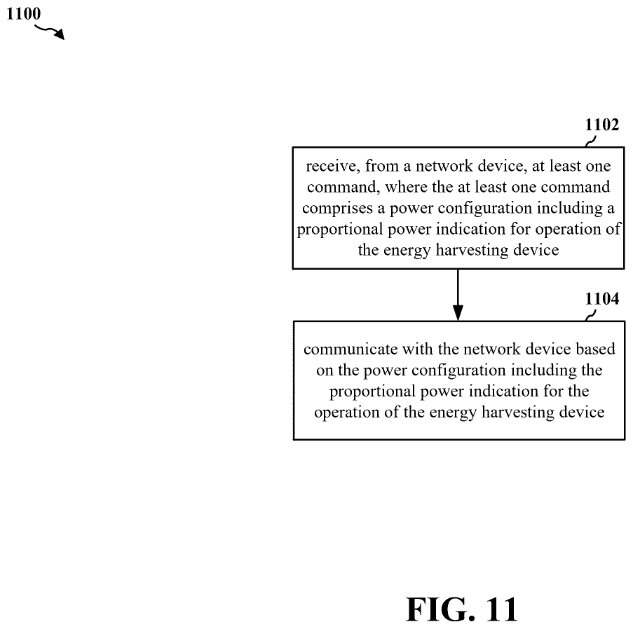

FIG. 11 is a flowchart 1100 of a method of wireless communication. The method may be performed by an EH device (e.g., the UE 104; the apparatus 1304). One or more of the illustrated operations may be omitted, transposed, or contemporaneous

At 1102, the EH device may receive at least one command. For example, 1102 may be performed by tag component 198 of apparatus 1304. The EH device may receive the at least one command from a network device. The at least one command may comprise a power configuration including a proportional power indication for operation of the EH device. In some aspects, the proportional power indication may indicate an amount of power usage of a battery of the EH device and a direct energy that may be utilized during a time interval. In some instances, the time interval may be based on one or more time units. In some instances, the time interval may be based on reception of a new command. For example, the time interval may terminate upon receipt of a new command. In some aspects, the EH device may be comprised within a main radio device. The main radio device may comprise a UE. In some aspects, the EH device may be controlled by the main radio device to negotiate values of the proportional power indication or when the EH device is in an active state.

At 1104, the EH device may communicate with the network device. For example, 1104 may be performed by tag component 198 of apparatus 1304. The EH device may communicate with the network device based on the power configuration including the proportional power indication for the operation of the EH device. in some aspects, at least one of a receive power, an energy conversion efficiency, a harvesting duration, an amount of harvested power, a EH device active duration, or a EH device power consumption may be provided to the network device. Different values for the harvesting duration or the EH device active duration may be provided to the network device for different values of the receive power.

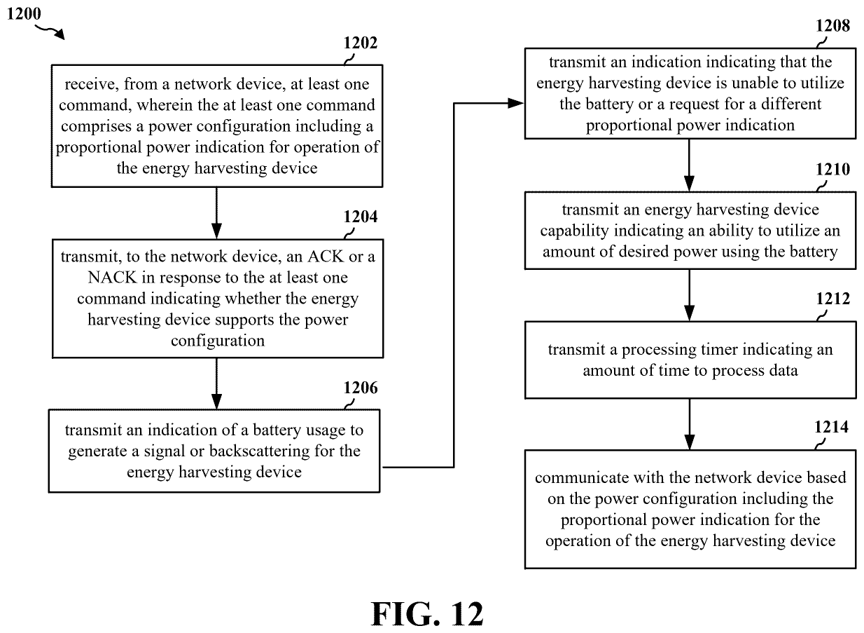

FIG. 12 is a flowchart 1200 of a method of wireless communication. The method may be performed by an EH device (e.g., the UE 104; the apparatus 1304). One or more of the illustrated operations may be omitted, transposed, or contemporaneous.

At 1202, the EH device may receive at least one command. For example, 1202 may be performed by tag component 198 of apparatus 1304. The EH device may receive the at least one command from a network device. The at least one command may comprise a power configuration including a proportional power indication for operation of the EH device. In some aspects, the proportional power indication may indicate an amount of power usage of a battery of the EH device and a direct energy that may be utilized during a time interval. In some instances, the time interval may be based on one or more time units. In some instances, the time interval may be based on reception of a new command. For example, the time interval may terminate upon receipt of a new command. In some aspects, the EH device may be comprised within a main radio device. The main radio device may comprise a UE. In some aspects, the EH device may be controlled by the main radio device to negotiate values of the proportional power indication or when the EH device is in an active state.

At 1204, the EH device may transmit an ACK or a NACK in response to the at least one command. For example, 1204 may be performed by tag component 198 of apparatus 1304. The EH device may transmit the ACK or the NACK to the network device. The ACK or the NACK may indicate whether the EH device supports the power configuration. In some aspects, the ACK or the NACK in response to the at least one command may be transmitted by a main radio device when the main radio device is in an active state. In some aspects, the EH device may transmit the ACK or the NACK in response to the at least one command when the main radio device is in an inactive state. In some aspects, feedback related to backscattering may be transmitted by the main radio device when the main radio device is in an active state. In some aspects, feedback related to backscattering and the ACK or the NACK in response to the at least one command may be transmitted by the EH device. The ACK or the NACK, in response to the at least one command, may be bundled for a plurality of commands. For example, the ACK or NACK may be bundled every K commands such that feedback for the K commands may be sent by the main radio or backscattered by the EH device. In some aspects, a HARQ-ACK of a reading process for the EH device may be provided to the main radio device, such that the EH device may provide a response to the HARQ-ACK via backscatter.

At 1206, the EH device may transmit an indication of a battery usage. For example, 1206 may be performed by tag component 198 of apparatus 1304. The EH device may transmit the indication of the battery usage to the network device. The EH device may transmit the indication of the battery usage to generate a signal or backscattering for the EH device.

At 1208, the EH device may transmit an indication related to the battery usage or the proportional power indication. For example, 1208 may be performed by tag component 198 of apparatus 1304. In some aspects, the EH device may transmit an indication indicating that the EH device is unable to utilize the battery. For example, the battery may not be utilized because the batter has expired or does not have a sufficient charge to meet the requirements of the EH device. In some aspects, the EH device may transmit an indication indicating a request for a different proportional power indication. For example, a new proportional power indication may be needed if the current proportional power indication is invalid or has expired.

At 1210, the EH device may transmit a EH device capability. For example, 1210 may be performed by tag component 198 of apparatus 1304. The EH device capability may indicate an ability of the EH device to utilize an amount of desired power using the battery. The EH device may transmit the EH device capability to the network device. For example, the EH device may indicate that the EH device may or may not be able to use the desired amount of power from the battery in response to the at least one command.

At 1212, the EH device may transmit a processing timer indication. For example, 1212 may be performed by tag component 198 of apparatus 1304. The processing timer indication may indicate an amount of time to process data. The processing timer may indicate an active time, where a harvest time to collect energy may be based on the active time. In some aspects, the processing timer may be provided to the network device in response to the at least one command.

At 1214, the EH device may communicate with the network device. For example, 1214 may be performed by tag component 198 of apparatus 1304. The EH device may communicate with the network device based on the power configuration including the proportional power indication for the operation of the EH device. in some aspects, at least one of a receive power, an energy conversion efficiency, a harvesting duration, an amount of harvested power, a EH device active duration, or a EH device power consumption may be provided to the network device. Different values for the harvesting duration or the EH device active duration may be provided to the network device for different values of the receive power.

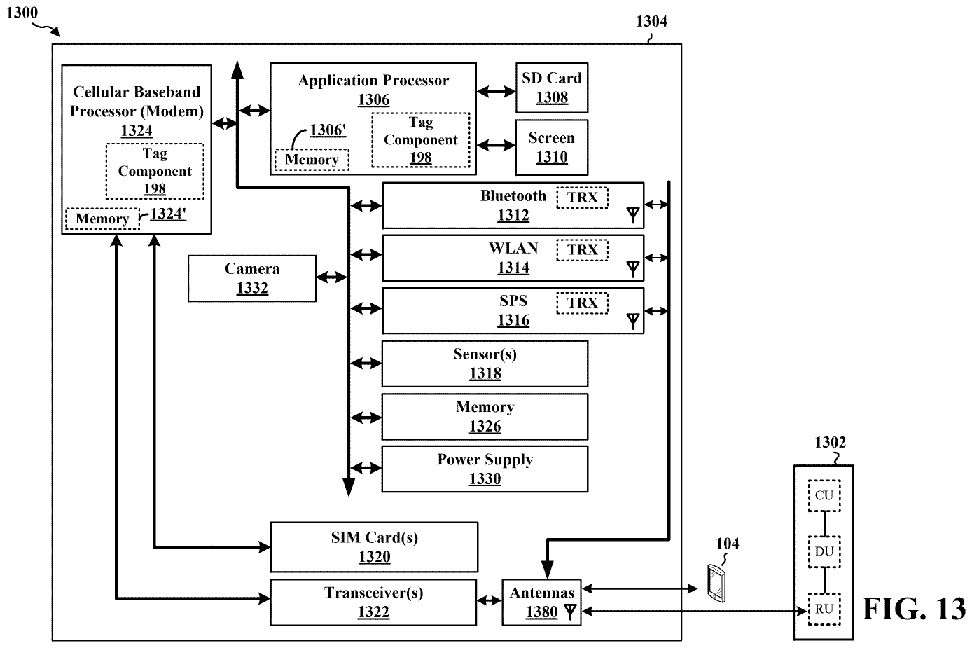

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to receive, from a network device, at least one command, wherein the at least one command comprises a power configuration including a proportional power indication for operation of the energy harvesting device; and communicate with the network device based on the power configuration including the proportional power indication for the operation of the energy harvesting device. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving, from a network device, at least one command. The at least one command comprises a power configuration including a proportional power indication for operation of the energy harvesting device. The apparatus includes means for communicating with the network device based on the power configuration including the proportional power indication for the operation of the energy harvesting device. The apparatus further includes means for transmitting, to the network device, an ACK or a NACK in response to the at least one command indicating whether the energy harvesting device supports the power configuration. The apparatus further includes means for transmitting an indication of a battery usage to generate a signal or backscattering for the energy harvesting device. The apparatus further includes means for transmitting an indication indicating that the energy harvesting device is unable to utilize the battery or a request for a different proportional power indication. The apparatus further includes means for transmitting a energy harvesting device capability indicating an ability to utilize an amount of desired power using the battery. The apparatus further includes means for transmitting a processing timer indicating an amount of time to process data. The processing timer indicates an active time, wherein a harvest time to collect energy is based on the active time. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

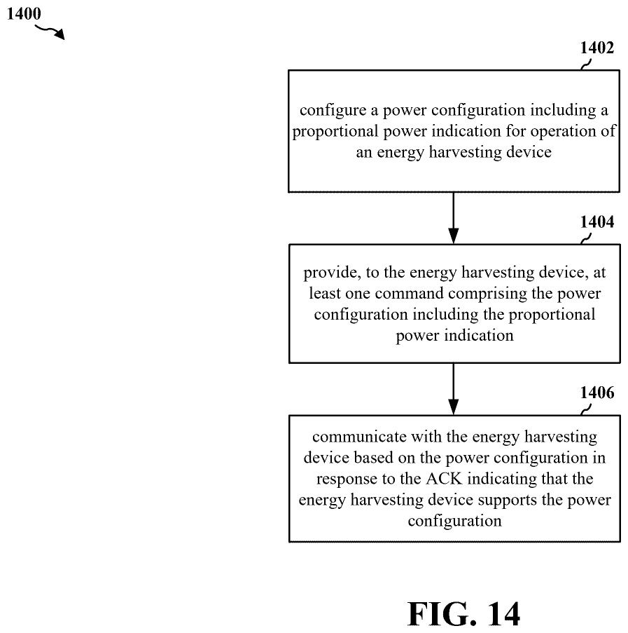

FIG. 14 is a flowchart 1400 of a method of wireless communication. The method may be performed by a network device or a wireless device (e.g., the base station 102; the network entity 1502. One or more of the illustrated operations may be omitted, transposed, or contemporaneous.

At 1402, the network device may configure a power configuration. For example, 1402 may be performed by configuration component 199 of network entity 1502. The power configuration may include a proportional power indication for operation of a EH device.

At 1404, the network device may provide at least one command comprising the power configuration including the proportional power indication. For example, 1404 may be performed by configuration component 199 of network entity 1502. The network device may provide the at least one command to the EH device.

At 1406, the network device may communicate with the EH device based on the power configuration. For example, 1408 may be performed by configuration component 199 of network entity 1502. In some aspects, the network device may communicate with the EH device based on the power configuration including the proportional power indication for the operation of the energy harvesting device.

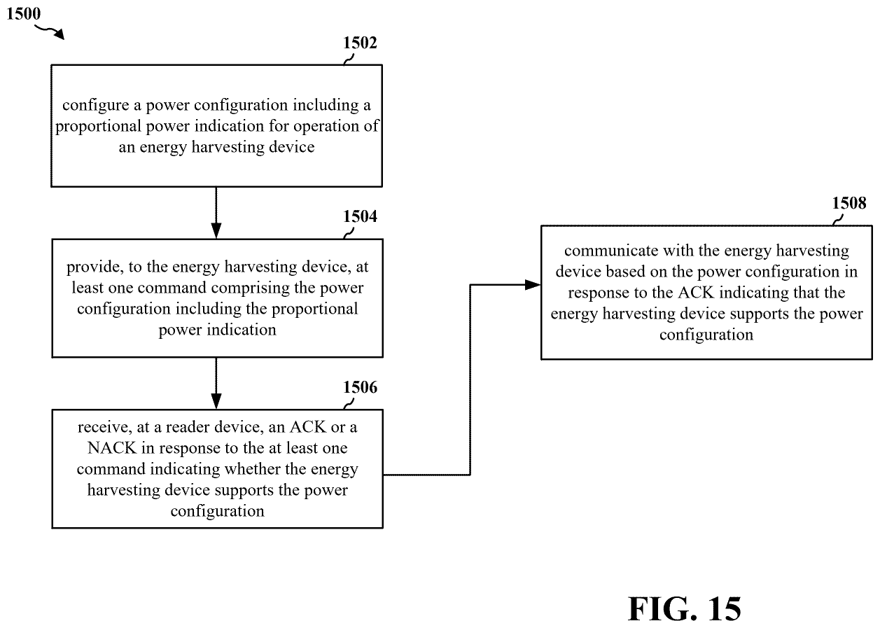

FIG. 15 is a flowchart 1500 of a method of wireless communication. The method may be performed by a network device or a wireless device (e.g., the base station 102; the network entity 1602. One or more of the illustrated operations may be omitted, transposed, or contemporaneous.

At 1502, the network device may configure a power configuration. For example, 1502 may be performed by configuration component 199 of network entity 1602. The power configuration may include a proportional power indication for operation of a EH device.

At 1504, the network device may provide at least one command comprising the power configuration including the proportional power indication. For example, 1504 may be performed by configuration component 199 of network entity 1602. The network device may provide the at least one command to the EH device.

At 1506, a reader device may receive an ACK or a NACK in response to the at least one command. For example, 1506 may be performed by configuration component 199 of network entity 1602. The ACK or the NACK may indicate whether the EH device supports the power configuration. In some aspects, the reader device is comprised within the network device. In some aspects, the reader may be a component within the network device or the network device itself.

At 1508, the network device may communicate with the EH device based on the power configuration. For example, 1508 may be performed by configuration component 199 of network entity 1602. In some aspects, the network device may communicate with the EH device based on the power configuration including the proportional power indication for the operation of the energy harvesting device. In some aspects, for example, the network device receives an ACK indicating that the EH device supports the power configuration. In some aspects, for example, if the network device receives a NACK which may indicate that the EH device may not support the power configuration, the network device may configure a new or updated power configuration having a new or updated proportional power indication.

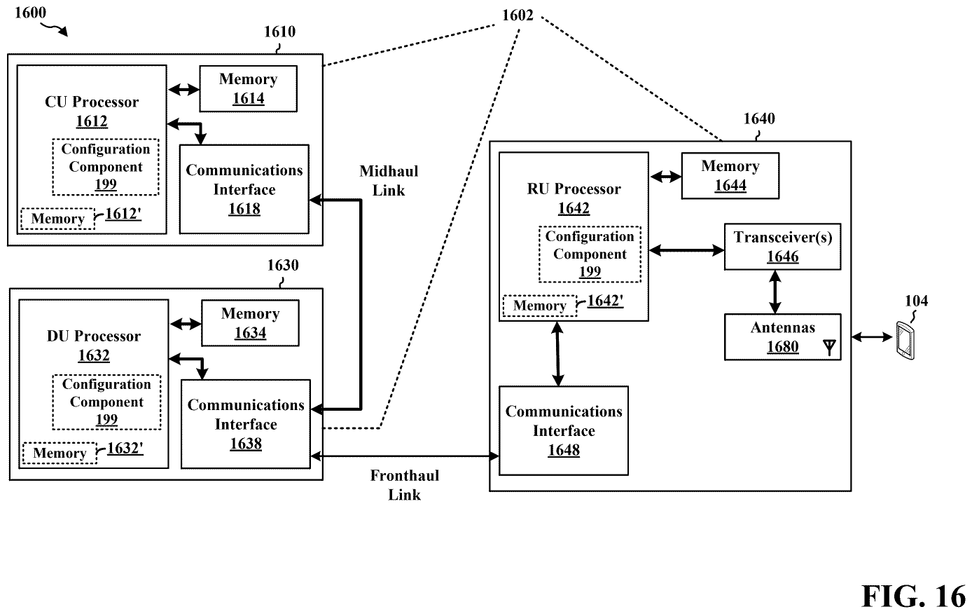

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to configure a power configuration including a proportional power indication for operation of a energy harvesting device; provide, to the energy harvesting device, at least one command comprising the power configuration including the proportional power indication; receive, at a reader device, an ACK or a NACK in response to the at least one command indicating whether the energy harvesting device supports the power configuration, wherein the reader device is comprised within the network device; and communicate with the energy harvesting device based on the power configuration in response to the ACK indicating that the energy harvesting device supports the power configuration. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for configuring a power configuration including a proportional power indication for operation of a energy harvesting device. The network entity includes means for providing, to the energy harvesting device, at least one command comprising the power configuration including the proportional power indication. The network entity includes means for communicating with the energy harvesting device based on the power configuration including the proportional power indication for the operation of the energy harvesting device. The network entity further includes means for receiving, at a reader device, an ACK or a NACK in response to the at least one command indicating whether the energy harvesting device supports the power configuration, wherein the reader device is comprised within the network device. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

As noted above, a device (e.g., a UE) may include a EH harvesting modality (e.g., a backscatter radio). In an example, the device may receive an energy transfer signal from a network node. The device may harvest energy from the energy transfer signal to perform an operation during a communication phase with the network node. The device may receive a power configuration comprising a proportional power indication for operation of the EH device. The proportional power indication may indicate an amount of power usage of the battery and an amount of direct energy utilized by the EH device during a time interval. At least one advantage of the disclosure is that the power configuration may allow for efficient use of the battery and the harvested energy for operation of the EH device.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication of an energy harvesting device comprising a battery comprising receiving, from a network device, at least one command, wherein the at least one command comprises a power configuration including a proportional power indication for operation of the energy harvesting device; and communicating with the network device based on the power configuration including the proportional power indication for the operation of the energy harvesting device.
Aspect 2 is the method of aspect 1, further includes that the proportional power indication indicates an amount of power usage of the battery and of a direct energy is utilized during a time interval.
Aspect 3 is the method of any of aspects 1 and 2, further includes that the time interval is based on one or more time units or reception of a new command.
Aspect 4 is the method of any of aspects 1-3, further includes that the energy harvesting device is comprised within a main radio device.
Aspect 5 is the method of any of aspects 1-4, further includes that the energy harvesting device is controlled by the main radio device to negotiate values of the proportional power indication or when the energy harvesting device is in an active state.
Aspect 6 is the method of any of aspects 1-5, further including transmitting, to the network device, an ACK or a NACK in response to the at least one command indicating whether the energy harvesting device supports the power configuration.
Aspect 7 is the method of any of aspects 1-6, further includes that the ACK or the NACK in response to the at least one command is transmitted by a main radio device when the main radio device is in an active state.
Aspect 8 is the method of any of aspects 1-7, further includes that feedback related to backscattering is transmitted by a main radio device when the main radio device is in an active state.
Aspect 9 is the method of any of aspects 1-8, further includes that feedback related to backscattering and the ACK or the NACK in response to the at least one command is transmitted by the energy harvesting device.
Aspect 10 is the method of any of aspects 1-9, further including transmitting an indication of a battery usage to generate a signal or backscattering for the energy harvesting device.
Aspect 11 is the method of any of aspects 1-10, further includes that the ACK or the NACK in response to the at least one command is bundled for a plurality of commands.
Aspect 12 is the method of any of aspects 1-11, further includes that a HARQ-ACK of a reading process for the energy harvesting device is provided to a main radio device, wherein the energy harvesting device provides a response to the HARQ-ACK via backscatter.
Aspect 13 is the method of any of aspects 1-12, further including transmitting an indication indicating that the energy harvesting device is unable to utilize the battery or a request for a different proportional power indication.
Aspect 14 is the method of any of aspects 1-13, further including transmitting an energy harvesting device capability indicating an ability to utilize an amount of desired power using the battery.
Aspect 15 is the method of any of aspects 1-14, further including transmitting a processing timer indicating an amount of time to process data, wherein the processing timer indicates an active time, wherein a harvest time to collect energy is based on the active time.
Aspect 16 is the method of any of aspects 1-15, further includes that the processing timer is provided in response to the at least one command.
Aspect 17 is the method of any of aspects 1-16, further includes that at least one of a receive power, an energy conversion efficiency, a harvesting duration, an amount of harvested power, an energy harvesting device active duration, or an energy harvesting device power consumption is provided to the network device.
Aspect 18 is the method of any of aspects 1-17, further includes that different values for the harvesting duration or the energy harvesting device active duration are provided for different values of the receive power.
Aspect 19 is an apparatus for wireless communication at a UE including at least one processor coupled to a memory and at least one transceiver, the at least one processor configured to implement any of aspects 1-18.
Aspect 20 is an apparatus for wireless communication at a UE including means for implementing any of aspects 1-18.
Aspect 21 is a computer-readable medium storing computer executable code, where the code when executed by a processor causes the processor to implement any of aspects 1-18.
Aspect 22 is a method of wireless communication at a network device comprising configuring a power configuration including a proportional power indication for operation of an energy harvesting device; providing, to the energy harvesting device, at least one command comprising the power configuration including the proportional power indication; and communicating with the energy harvesting device based on the power configuration including the proportional power indication for the operation of the energy harvesting device.
Aspect 23 is the method of aspect 22, further including receiving, at a reader device, an ACK or a NACK in response to the at least one command indicating whether the energy harvesting device supports the power configuration, wherein the reader device is comprised within the network device.
Aspect 24 is an apparatus for wireless communication at a network device including at least one processor coupled to a memory and at least one transceiver, the at least one processor configured to implement any of aspects 22 and 23.
Aspect 25 is an apparatus for wireless communication at a network device including means for implementing any of aspects 22 and 23.
Aspect 26 is a computer-readable medium storing computer executable code, where the code when executed by a processor causes the processor to implement any of aspects 22 and 23.

1. An apparatus for wireless communication of an energy harvesting device comprising a battery, comprising:
a memory; and
at least one processor coupled to the memory and, based at least in part on information stored in the memory, the at least one processor is configured to:
receive, from a network device, at least one command, wherein the at least one command comprises a power configuration including a proportional power indication for operation of the energy harvesting device; and
communicate with the network device based on the power configuration including the proportional power indication for the operation of the energy harvesting device.

2. The apparatus of claim 1, further comprising a transceiver coupled to the at least one processor.

3. The apparatus of claim 1, wherein the proportional power indication indicates an amount of power usage of the battery and of a direct energy is utilized during a time interval.

4. The apparatus of claim 3, wherein the time interval is based on one or more time units or reception of a new command.

5. The apparatus of claim 1, wherein the energy harvesting device is comprised within a main radio device.

6. The apparatus of claim 5, wherein the energy harvesting device is controlled by the main radio device to negotiate values of the proportional power indication or when the energy harvesting device is in an active state.

7. The apparatus of claim 1, wherein the at least one processor is configured to:
transmit, to the network device, an acknowledgement (ACK) or a negative ACK (NACK) in response to the at least one command indicating whether the energy harvesting device supports the power configuration.

8. The apparatus of claim 7, wherein the ACK or the NACK in response to the at least one command is transmitted by a main radio device when the main radio device is in an active state.

9. The apparatus of claim 7, wherein feedback related to backscattering is transmitted by a main radio device when the main radio device is in an active state.

10. The apparatus of claim 7, wherein feedback related to backscattering and the ACK or the NACK in response to the at least one command is transmitted by the energy harvesting device.

11. The apparatus of claim 7, wherein the at least one processor is configured to:
transmit an indication of a battery usage to generate a signal or backscattering for the energy harvesting device.

12. The apparatus of claim 7, wherein the ACK or the NACK in response to the at least one command is bundled for a plurality of commands.

13. The apparatus of claim 7, wherein a hybrid automatic repeat request (HARQ) ACK (HARQ-ACK) of a reading process for the energy harvesting device is provided to a main radio device, wherein the energy harvesting device provides a response to the HARQ-ACK via backscatter.

14. The apparatus of claim 1, wherein the at least one processor is configured to:
transmit an indication indicating that the energy harvesting device is unable to utilize the battery or a request for a different proportional power indication.

15. The apparatus of claim 1, wherein the at least one processor is configured to:
transmit an energy harvesting device capability indicating an ability to utilize an amount of desired power using the battery.

16. The apparatus of claim 1, wherein the at least one processor is configured to:
transmit a processing timer indicating an amount of time to process data, wherein the processing timer indicates an active time, wherein a harvest time to collect energy is based on the active time, and wherein the processing timer is provided in response to the at least one command.

17. (canceled)

18. The apparatus of claim 1, wherein at least one of a receive power, an energy conversion efficiency, a harvesting duration, an amount of harvested power, an energy harvesting device active duration, or an energy harvesting device power consumption is provided to the network device.

19. The apparatus of claim 18, wherein different values for the harvesting duration or the energy harvesting device active duration are provided for different values of the receive power.

20. A method of wireless communication of an energy harvesting device comprising a battery, comprising:
receiving, from a network device, at least one command, wherein the at least one command comprises a power configuration including a proportional power indication for operation of the energy harvesting device; and
communicating with the network device based on the power configuration including the proportional power indication for the operation of the energy harvesting device.

21-27. (canceled)

28. An apparatus for wireless communication at a network device, comprising:
a memory; and
at least one processor coupled to the memory and, based at least in part on information stored in the memory, the at least one processor is configured to:
configure a power configuration including a proportional power indication for operation of an energy harvesting device;
provide, to the energy harvesting device, at least one command comprising the power configuration including the proportional power indication; and
communicate with the energy harvesting device based on the power configuration including the proportional power indication for the operation of the energy harvesting device.

29-30. (canceled)
